(19) United States
(12) Patent Application Publication
(10) Pub. No.: US 2022/0344652 A1
(43) Pub. Date: Oct. 27, 2022

(54) SILICON-BASED MATERIAL, METHOD FOR PRODUCING THE SAME AND APPLICATIONS THEREOF

(71) Applicant: ETERNAL MATERIALS CO., LTD., Kaohsiung (TW)

(72) Inventor: HSIAO-HSUAN SHEN, KAOHSIUNG (TW)

(73) Assignee: ETERNAL MATERIALS CO., LTD., KAOHSIUNG (TW)

(21) Appl. No.: 17/724,586

(22) Filed: Apr. 20, 2022

(30) Foreign Application Priority Data
Apr. 23, 2021 (TW) 110114814

(51) Int. Cl. H01M 4/485; H01M 4/36; H01M 4/583

(52) U.S. Cl. CPC H01M 4/485; H01M 4/364; H01M 4/583; H01M 2004/027

(57) ABSTRACT

The invention provides a silicon-based material and a method for producing the same. In all X-ray diffraction pattern obtained by using Cu Kα rays, the silicon-based material includes the following characteristic peaks: (A) a characteristic peak at 2θ=23°±1° with an intensity I_{A}; (B) a characteristic peak at 2θ=28°±0.5° with an intensity I_{B}; (C) a characteristic peak at 2θ=48°±1° with an intensity I_{C}; and (D) a characteristic peak at 2θ=56°±1° with an intensity I_{D}, wherein: 1.2≤I_{B}/I_{A}≤1.7; 1.8≤I_{B}/I_{C}≤2.3; and 1.6≤I_{B}/I_{D}≤3.0. The present invention also provides a battery negative electrode including the silicon-based material.

### 1. FIELD OF THE INVENTION

The present invention relates to a silicon-based material and a method for producing the same, and particularly to a silicon-based material suitable for use in a negative electrode of a lithium ion battery and a method for producing the same. The present invention also relates to a battery negative electrode comprising the silicon-based material.

### 2. DESCRIPTION OF THE RELATED ART

Lithium-ion batteries are relatively light weight and high capacity (that is, high energy density), have high working voltage, rechargeable cycles and high cycle life, and thus are widely used as a driving power supply for portable devices. In response to environmental concerns, lithium-ion batteries are expected to become increasingly widespread as driving power and standby power supplies in power systems (for example, automobiles). The driving power supply in a power system requires, in addition to high energy density and long cycle life, rate capability and capacity retention rate at high C-rate.

The negative electrode material of a conventional lithium-ion battery comprises a carbon-based material, such as graphite. Graphite has a good layered structure, which is conducive to the intercalation and deintercalation of lithium ions. However, the theoretical capacity of graphite is only about 372 mAh/g, which will ultimately fall short of future needs. Among non-carbon-based negative electrode materials, silicon-based material has attracted much attention for its high theoretical capacity (4,200 mAh/g). Common silicon-based materials in the literature include Si, SiOₓ (0<x<2), SiO₂, C-SiO and SiM (M: metal).

However, compared to the carbon-based materials, a solid electrolyte interface (SEI) is formed with more lithium ions in the electrolyte solution on the surface of the silicon-based material during the first charge process, causing the consumption of a greater amount of lithium ions. Therefore, lithium-ion batteries with a silicon-based material as a negative electrode material may suffer from poor coulombic efficiency for the first charge-discharge cycle (tat coulombic efficiency), leading to a less increased energy density in lithium-ion batteries than expected. Moreover, during the charge and discharge processes, the intercalation and deintercalation of lithium ions cause great volume expansion and contraction of silicon-based materials. This causes the negative electrode structure to easily disintegrate, which in turn affects the capacity retention. The disintegration becomes more prominent during fast charge and discharge or when the current intensity is high.

Therefore, the development of a new negative electrode material to improve the 1^{st} coulombic efficiency, achieve a high capacity retention and improve the rate capability of secondary batteries such as lithium-ion batteries is a technical subject in urgent need of a solution.

### SUMMARY OF THE INVENTION

In view of this, the present inventors found through research a silicon-based material, a method for producing the same, and uses thereof that can solve the above-mentioned problems.

An object of the present invention is to provide a silicon-based material. The X-ray diffraction pattern obtained using Cu Ku rays of the silicon-based material has the following characteristic peaks:
(A) a characteristic peak at 2θ=23°±1° with an intensity I_{A};
(B) a characteristic peak at 2θ=28°±0.5° with an intensity I_{B};
(C) a characteristic peak at 2θ=48°±1 with an intensity I_{C}; and
(D) a characteristic peak at 2θ=56°±1° with an intensity I_{D},
in which
1.2≤I_{B}/I_{A}≤1.7;
1.8≤I_{B}/I_{C}≤2.3; and
1.65≤I_{B}/I_{D}≤3.0.

Another object of the present invention is to provide a method for preparing a silicon-based material, which comprises: mixing a metal source compound, a carbon source compound and a silicon oxide raw material with water to obtain an aqueous mixture; and subjecting the aqueous mixture to heat treatment.

Another object of the present invention is to provide a battery negative electrode, which comprises a silicon-based material of the present invention.

The silicon-based material of the present invention can effectively overcome the shortcomings of conventional negative electrode materials. For example, the silicon-based material of the present invention is relatively low alkaline, and has better operability. A battery using it as a negative electrode material has high 1^{st} coulombic efficiency, high rate capability, high capacity retention during fast charge and discharge or when the current intensity is high, and other advantages.

Those of ordinary skill in the art to which the present invention belongs can easily understand the fundamental spirit of the present invention and the technical means adopted in the present invention and the preferred embodiments from reading the embodiments to be described.

### BRIEF DESCRIPTION OF THE DRAWINGS

FIG. 1 shows an X-ray diffraction pattern (Cu Ku rays) of the silicon-based material prepared in Example 1.

FIG. 2 shows an X-ray diffraction pattern (Cu Kα rays) of the silicon-based material prepared in Example 2.

FIG. 3 shows all X-ray diffraction pattern (Cu Kα rays) of the silicon-based material prepared in Example 3.

FIG. 4 shows an X-ray diffraction pattern (Cu Kα rays) of the silicon-based material prepared in Example 4.

FIG. 5 shows an X-ray diffraction pattern (Cu Kα rays) of the silicon-based material prepared in Example 5.

FIG. 6 shows an X-ray diffraction pattern (Cu Kα rays) of the silicon-based material prepared in Example 6.

FIG. 7 shows an X-ray diffraction pattern (Cu Kα rays) of the silicon-based material prepared in Example 7.

FIG. 8 shows an X-ray diffraction pattern (Cu Kα rays) of the silicon-based material prepared in Example 8.

FIG. 9 shows an X-ray diffraction pattern (Cu Kα rays) of the silicon-based material prepared in Comparative Example 1.

FIG. 10 shows an X-ray diffraction pattern (Cu Kα rays) of the silicon-based material prepared in Comparative Example 2.

FIG. 11 shows an X-ray diffraction pattern (Cu Kα rays) of the silicon-based material prepared in Comparative Example 3.

FIG. 12 shows an X-ray diffraction pattern (Cu Kα rays) of the silicon-based material prepared in Comparative Example 4.

FIG. 13 shows an X-ray diffraction pattern (Cu Kα rays) of the silicon-based material prepared in Comparative Example 5.

FIG. 14 shows an X-ray diffraction pattern (Cu Kα rays) of the silicon-based material prepared in Comparative Example 6.

FIG. 15 shows an X-ray diffraction pattern (Cu Kα rays) of the silicon-based material prepared in Comparative Example 7.

FIG. 16 shows an X-ray diffraction pattern (Cu Kα rays) of the silicon-based material prepared in Comparative Example 8.

### DETAILED DESCRIPTION

In order to facilitate understanding of the disclosure herein, certain terms are defined below.

The term “about” refers to an acceptable deviation of a given value measured by a person of ordinary skill in the art, depending in part on how the value is measured or determined.

Herein, unless otherwise specified, the singular forms “a” and “the” also include the plural form. Any and all exemplary and illustrative terms (“e.g.” and “such as”) herein are only for the purpose of further highlighting the present invention, instead of limiting its scope. The terminology in the specification of this invention should not be regarded as implying that any unclaimed methods or conditions can constitute essential features in implementing the present invention.

The word “or” in a list of two or more items covers all of the following interpretations: any of the items in the list, all items in the list, and any combination of items in the list.

The present invention will be described in detail below.

[Silicon-Based Material]

The X-ray diffraction pattern obtained using Cu Kα rays of the silicon-based material of the present invention has the following characteristic peaks:
(A) a characteristic peak at 2θ=23°±1° with an intensity I_{A};
(B) a characteristic peak at 2θ=28°±0.5° with an intensity I_{B};
(C) a characteristic peak at 2θ=48°±1 with an intensity I_{C}; and
(D) a characteristic peak at 2θ=56°±1° with an intensity I_{D},
in which
1.2≤I_{B}/I_{A}1.7;
1.81≤I_{B}/I_{C}≤2.3; and
1.6≤I_{B}/I_{D}≤3.0.

After extensive research, the present inventors unexpectedly found that the silicon-based material of the present invention has the aforementioned specific positions and relative intensities of the characteristic peaks in the X-ray diffraction pattern. When the silicon-based material is used in a battery negative electrode (such as a negative electrode of a lithium ion battery), 1^{st} coulombic efficiency, capacity retention at high C-rate, rate capability and other favorable properties are exhibited.

In the X-ray diffraction pattern of the silicon-based material, characteristic peaks are obtained at different diffraction angles (20). For example, the characteristic peak at 2θ=23°±1° may be attributed to the characteristic peak of SiO₂; the characteristic peak at 2θ=28°±0.5° may be attributed to the characteristic peak of the crystal plane (111) of Si; the characteristic peak at 2θ=48°±1° may be attributed to the characteristic peak of the crystal plane (220) of Si; and the characteristic peak at 2θ=56°±1° may be attributed to the characteristic peak of the crystal plane (311) of Si.

The silicon-based material of the present invention includes a silicon compound particle, a carbon material and a metal element. The silicon compound particle may include the silicon compound SiOₓ, where 0≤x≤2. The carbon material may be formed by carbonizing a carbon source compound (for example, citric acid, malic acid, tartaric acid, polyacrylic acid, and maleic acid). The metal element is not particularly limited, and preferably, is an alkali metal or alkaline earth metal.

Conventionally, when a silicon-based material is used as a negative electrode active material in lithium-ion batteries, during the first charge process (intercalation of lithium), the silicon-based material irreversibly reacts with lithium ions in the electrolyte solution to form an inert solid electrolyte interface (SEI). The formation of SEI consumes a large amount of lithium ions, causing an irreversibly high capacity loss of the lithium-ion battery during the first charge and discharge process, thus severely restricting the use of silicon-based materials in high-energy-density lithium-ion batteries. To overcome the problem of irreversibly high capacity loss of the silicon-based negative electrode material, lithium may be added to the negative electrode by pre-treatment (for example, prelithiation), to offset the irreversible lithium loss caused by the formation of the SEI film and improve the 1^{st} coulombic efficiency. However, the pretreated negative electrode material is highly alkaline (with a pH value in the range of about 9 to about 13). The high alkaline environment prevents the adhesive material from being able to firmly attach to the surface of a metal current collector (such as a copper foil or an aluminum foil), causing a decrease in adhesion. Therefore, the various materials in the electrode sheet cannot be firmly bonded and are prone to pulverization, which affects the electrochemical performance of the obtained battery.

After an appropriate amount of silicon-based material is fully mixed with an appropriate amount of water (for example, deionized water) and allowed to stand for equilibrium, the pH value of the silicon-based material can be measured. The pH value of the silicon-based material of the present invention can be controlled within the range of about 7 to about 11 (for example: 7, 8, 9, 10 or 11). The pH value of the silicon-based material of the present invention can be adjusted to be in a weakly basic range, preferably in the range of about 7 to about 9, and more preferably, less than 9 (for example, in the range of about 7 to about 8.5). Compared with conventional silicon-based materials which are highly alkaline, the silicon-based material of the present invention allows a binder to have a variety of material choices, and effectively improves the operability and reduces restrictions during use.

In some embodiments, the silicon-based material of the present invention is obtained by heat treatment (for example, high-temperature calcination) of a silicon oxide raw material, a metal source compound, and a carbon source compound in an aqueous phase. The silicon oxide raw material can be represented by SiO_{y}, where 0<y<2. The metal source provided by the metal source compound is, for example, but not limited to, an alkali metal or alkaline earth metal. In an embodiment of the present invention, the metal source compound is lithium hydroxide. In an embodiment of the present invention, the carbon source compound includes a carboxylic acid compound. In an embodiment of the present invention, the carbon source compound is citric acid.

The conventional silicon-based material is prepared by a solid-phase method, to generate a silicate. The silicate is preferably lithium silicate, such as Li₂SiO₃, Li₂Si₂O₅ or Li₄SiO₄. In contrast, the silicon-based material of the present invention is prepared by an aqueous phase method, and lithium silicate is not included. Therefore, in the X-ray diffraction pattern obtained using Cu Kα rays, the silicon-based material of the present invention does not have the characteristic peaks of lithium silicate Li₂SiO₃. Li₂Si₂O₅ or Li₄SiO₄. For example, the silicon-based material of the present invention does not contain Li₂SiO₃, so the X-ray diffraction pattern of the silicon-based material of the present invention does not have the characteristic peaks at 2θ=19°±1°, 27°±0.5° and 33°±1°. Alternatively, the silicon-based material of the present invention does not contain Li₂Si₂O₅, so the X-ray diffraction pattern of the silicon-based material of the present invention does not have the characteristic peaks at 2θ=24.4°-25.0° and 39°±1°. Alternatively, the silicon-based material of the present invention does not contain Li₄SiO₄, so the X-ray diffraction pattern of the silicon-based material of the present invention does not have the characteristic peaks at 2θ=22°±1° and 34.5°±0.5°.

The silicon compound particles used in the silicon-based material of the present invention may include Si, SiO₂ and SiOₓ, where 0<x<2. In order for the silicon-based material of the present invention to provide the specific capacity required by a negative electrode when used in the negative electrode, based on the total weight of the silicon-based material of the present invention taken as 100 wt %, the content of the silicon compound particles is 69 wt % to 98 wt %, for example, 69 wt %, 70 wt %, 75 wt %, 80 wt %, 85 wt %, 90 wt %, 95 wt % or 98 wt %.

The silicon-based material of the present invention includes a carbon material. The carbon material may be obtained by carbonizing a carbon source compound (for example, citric acid, malic acid, tartaric acid, polyaciylic acid, and maleic acid). The carbon material may be granular, and may be randomly distributed on the surface of the silicon compound particles, or inside the silicon compound particles, or blended with the silicon compound particles.

Based on the total weight of the silicon-based material of the present invention taken as 100 wt %, the content of the carbon material is 1 wt % to 30 wt %, for example: 1 wt %, 5 wt %, 10 wt %, 15 wt %, 20 wt %, 25 wt % or 30 wt %.

The metal element used in the silicon-based material of the present invention can be derived from a metal source compound. Preferably, the metal element is an alkali metal or alkaline earth metal. In some embodiments, the metal element used in the present invention is lithium, sodium, potassium or magnesium. Based on the total weight of the silicon-based material of the present invention taken as 100 wt %, the content of the metal element is 0.1 wt % to 1 wt %, such as 0.1 wt %, 0.3 wt %, 0.5 wt %, 0.8 wt % or 1 wt %.

The shape of the silicon-based material of the present invention is not particularly limited. In some embodiments, the silicon-based material of the present invention may have a spherical shape, an oval shape, a polygonal shape, an irregular shape, a sheet shape, a needle shape, a tube shape, or other possible shapes, or any combination thereof.

The physical properties of the silicon-based material of the present invention are not particularly limited.

In some embodiments, the silicon-based material of the present invention is in a powder form and has an average particle size (D₅₀) of 2 μm to 10 μm. According to a preferred embodiment of the present invention, the silicon-based material of the present invention has an average particle size (D₅₀) of 5 μm to 8 μm and D₉₀ of <15 μm.

The average particle size (D₅₀) and D₉₀ are particle characterization known to those of ordinary skill in the art to which the present invention belongs. D₅₀ and D₉₀ refer to the particle size when the volume-based cumulative amount reaches 50% and 90% in the cumulative particle size distribution curve. For example, D₅₀=10 μm means that particles with a particle size of less than 10 μm in the powder account for 50% of the volume of all powder particles. In the present invention, D₅₀ of the silicon-based material is as defined above, and D₉₀ is <30 μm (for example, <28 μm, <25 μm, <20 μm or <15 μm), preferably D₉₀ is <20 μm, and more preferably, D90<15 μm. In the present invention, D₅₀ and D₉₀ are measured by analyzing the particle size distribution of the powder using a dynamic light scattering (DLS) analyzer.

The silicon-based material of the present invention has the aforementioned specific positions and relative intensities of the characteristic peaks in the X-ray diffraction pattern. Therefore, the silicon-based material of the present invention has a specific crystallinity. When the silicon-based material of the present invention is applied to a negative electrode of a lithium-ion battery, better 1° coulombic efficiency, capacity retention at high C-rate, rate capability and other favorable properties are exhibited. For example, it can increase the energy density by at least 15%, and has excellent cycle performance. After 800 cycles of charge and discharge, the capacity retention is still >80%. Moreover, fast charge performance is exhibited. That is, the battery can be fully charged after a short amount of tune. In addition, the silicon-based material of the present invention can overcome the disadvantages of limited operability and increased restrictions in use caused by the excessively high alkaline conventional silicon-based materials.

[Preparation Method of Silicon-Based Material]

The method for preparing a silicon-based material of the present invention includes the following steps:
(a) mixing a metal source compound, a carbon source compound and a silicon oxide raw material with water to obtain an aqueous mixture; and
(b) subjecting the aqueous mixture to heat treatment.

The silicon oxide raw material may be silicon oxide SiO_{y}, where 0<y<2.

The metal source provided by the metal source compound is, for example, but not limited to, an alkali metal or alkaline earth metal. In some embodiments, the metal source compound is, for example, but not limited to, a metal hydroxide. In some embodiments, the metal hydroxide is selected from the group consisting of an alkali metal hydroxide and an alkaline earth metal hydroxide. In some embodiments, the metal hydroxide includes lithium hydroxide, sodium hydroxide, potassium hydroxide, magnesium hydroxide, or any combination thereof. In some embodiments, the metal hydroxide is preferably lithium hydroxide.

Without being bound by theory, the metal source compound (for example, but not limited to: alkali metal hydroxide) can convert the silicon oxide raw material represented by SiO_{y} (where 0<y<2) into Si and SiO₂. When applied to a negative electrode of a lithium-ion battery, it can improve the 1^{st} coulombic efficiency, rate capability and other properties.

In some embodiments, based on 100 parts by weight of the silicon oxide raw material, the amount of the metal source compound is 0.1 to 1 part by weight, such as 0.1, 0.2, 0.3, 0.4, 0.5, 0.6, 0.7, 0.8, 0.9, or 1 part by weight. If the amount of the metal source compound is less than 0.1 part by weight, the amount of the metal hydroxide may be insufficient to convert the silicon oxide raw material into the silicon compound of the present invention. If the amount of the metal source compound is greater than 1 part by weight, residues of reactants may cause the material to be more alkaline, which is unfavorable to the preparation of an electrode sheet.

The carbon source compound includes a carboxylic acid compound, for example, but not limited to, citric acid, malic acid, tartaric acid, polyacrylic acid, maleic acid, or any combination thereof. In some embodiments, the carbon source compound is preferably citric acid.

Without being bound by theory, the carbon source compound can not only produce a carbon material after heat treatment, but can also affect the crystallinity of the silicon-based material produced by the silicon oxide raw material after heat treatment.

In some embodiments, based on 100 parts by weight of the silicon oxide raw material, the amount of the carbon source compound is 5 to 35 part by weight, for example 5, 10, 15, 20, 25, 30, or 35 parts by weight, and preferably 10 to 30 parts by weight. If the amount of the carbon source compound is less than 5 parts by weight or more than 35 parts by weight, the silicon-based material produced after heat treatment may not have the positions or relative intensifies of the characteristic peaks in the X-ray diffraction pattern of the silicon-based material according to the present invention. As a result, the electrochemical performance may deteriorate (for example, at least one of 1^{st} coulombic efficiency, capacity retention at high C-rate, and rate capability may be poor).

In the method for preparing a silicon-based material of the present invention, the preparation method of the aqueous mixture in Step (a) is not particularly limited. Those of ordinary skill in the art to which the present invention belongs can mix the metal source compound, the carbon source compound and the silicon oxide raw material with water in any suitable manner to obtain the aqueous mixture. For example, the metal source compound and the carbon source compound can both be dissolved in water to prepare an aqueous solution of the metal source compound and carbon source compound. Then, the silicon oxide raw material is added to the aqueous solution, mixed and stirred until uniform to obtain the aqueous mixture of Step (a). The metal source compound and the carbon source compound may also be dissolved in water separately. Alternatively, the metal source compound, the carbon source compound and the silicon oxide raw material can be mixed in water together.

In the method for preparing a silicon-based material of the present invention, the heat treatment in Step (b) may be carried out in an inert atmosphere or a vacuum environment. The inert atmosphere includes at least one of nitrogen (N₂), helium (He), neon (Ne), argon (Ar) and other non-oxygen gases. The preparation system used in the heat treatment of Step (b) is not particularly limited. In some embodiments, the preparation system may be a continuous or batch-type apparatus, for example, but not limited to: a box furnace, a tube furnace, a tunnel furnace, or a rotary furnace, etc. In some embodiments, the operating temperature range of the heat treatment in Step (b) is 500° C. to 1500° C., preferably 800° C. to 1300° C., for example, 800° C., 900° C., 1000° C., 1100° C., 1200° C., or 1300° C., and more preferably 900° C. to 1200° C. The operating time may be 1 to 10 hrs, for example, 1, 2, 3, 4, 5, 6, 7, 8, 9, or 10 hrs, and preferably 3 to 5 hrs.

In some embodiments, the method above of preparing the silicon-based material may further include any other appropriate steps as needed, for example, pulverizing in a pulverizer, grinding and/or sieving, to reduce the particle size. This makes the silicon-based material have an average particle size (D₅₀) of 2 to 10 μm as measured by a dynamic light scattering (DLS) analyzer, such as an average particle size of 2, 3, 4, 5, 6, 7, 8, 9 or 10 μm; and preferably the silicon-based material has an average particle size of 5 to 8 pin and a D₉₀ of <15 μm as measured by a dynamic light scattering (DLS) analyzer.

Compared with the solid-phase preparation methods, the method for preparing a silicon-based material of the present invention is an aqueous phase preparation method. The silicon-based material of the present invention produced after heat treatment has the specific positions and relative intensities of the characteristic peaks in the X-ray diffraction pattern. When the silicon-based material is used in a battery negative electrode (such as a negative electrode of a lithium ion battery), 1° coulombic efficiency, capacity retention at high C-rate, rate capability and other favorable properties are exhibited.

Moreover, operations with the silicon-based material of the present invention can be done at a pH value in a weakly basic range, to give a slurry. Compared with conventional silicon-based materials which are known to be more alkaline, operations with the silicon-based material of the present invention can be done at a pH value below 9 to improve operability and reduce restrictions during use. Moreover, the silicon-based material of the present invention allows a binder to have a variety of material choices.

[Preparation Method of Battery Negative Electrode]

The present invention further provides a battery negative electrode, which comprises a silicon-based material as described above. The battery negative electrode may be a negative electrode of a secondary battery, for example, but not limited to, a negative electrode of a lithium ion battery. The preparation method of the battery negative electrode of the present invention is not particularly limited, and may be any suitable method known to those skilled in the art to which the present invention pertains. For example, the silicon-based material of the present invention can be added to a shiny of negative electrode materials, mixed well, coated on a substrate, and dried, to prepare a battery negative electrode.

Examples of the substrate include, but are not limited to, a copper foil or a copper foil coated with a carbon material.

In some embodiments, the slurry of negative electrode materials contains, in addition to the silicon-based material of the present invention as the negative electrode active material, a suitable carbon-based negative electrode active material known in the art to which the present invention pertains, for example, but not limited to, graphite, hard carbon, soft carbon or Mesocarbon Microbeads (MCMB), or any combination of the foregoing materials.

The slurry of negative electrode materials contains, in addition to the negative electrode active material, a suitable conductive material, binder and optional additive known in the art to which the present invention pertains. The type of additive is known to those with ordinary knowledge in the art to which the present invention belongs, for example, but not limited to, a tackifier, a dispersant, a pH-adjusting compound, or any combination thereof.

Examples of the conductive material include, for example, but are not limited to, conductive graphite, carbon black, carbon fibers, carbon nanotubes, graphene, other conductive materials, or any combination of the no foregoing materials.

Examples of the adhesive include, for example, but are not limited to, polyvinylidene fluoride (PVDF), styrene-butadiene copolymer, methyl (meth)acrylate, ethyl (meth)acrylate, butyl (meth)acrylate, (meth)acrylonitrile, hydroxyethyl (meth)acrylate, acrylic acid, methacrylic acid, fumaric acid, maleic acid, polyethylene oxide, polyepichlorohydrin, polyphosphazene or polyacrylonitrile, other suitable binding materials, or any combination of the foregoing materials.

According to an embodiment of the present invention, when the negative electrode containing the silicon-based material of the present invention is applied to a secondary battery (such as a lithium ion battery), a high 1^{st} coulombic efficiency, a high capacity retention during charge and discharge at a high C rate, a better rate capability, and other favorable properties are exhibited. Therefore, the obtained battery can have advantages such as high energy density, good cycle life, and fast charge and discharge rate capability, thus making it suitable for use in a driving power supply of a power system.

The present invention will now be described in connection with the following examples. The present invention may be implemented in other ways than the following examples without departing from the spirit of the present invention; and the scope of the present invention should not be explained merely in accordance with and limited by the disclosure.

### EXAMPLES

### Preparation of Silicon-Based Materials

### Examples 1 to 8 and Comparative Examples 1 to 8

### Example 1

Preparation of aqueous mixture: 1 g of lithium hydroxide (Aldrich) was mixed with 20 ml of water and stirred until the lithium hydroxide powder was dissolved. Then, 10 g of citric acid (J. T. Baker) was mixed with 80 ml of water and stirred until the citric acid powder was dissolved. The two solutions containing lithium hydroxide or citric acid respectively were mixed and stirred. 100 g of silica (Alderich 262951) was added and stirred for 1 hr.

Heat treatment: The above aqueous mixture was heated under nitrogen at 1200° C. for 3 hrs.

### Example 2

Preparation of aqueous mixture: 0.2 g of lithium hydroxide (Aldrich) was mixed with 20 ml of water and stirred until the lithium hydroxide powder was dissolved. Then, 20 g of citric acid (J. T. Baker) was mixed with 80 ml of water and stirred until the citric acid powder was dissolved. The two solutions containing lithium hydroxide or citric acid respectively were mixed and stirred. 100 g of silica (Alderich 262951) was added and stirred for 1 hr.

Heat treatment: The above aqueous mixture was heated under nitrogen at 1200° C. for 3 hrs.

### Example 3

Preparation of aqueous mixture: 0.1 g of lithium hydroxide (Aldrich) was mixed with 20 ml of water and stirred until the lithium hydroxide powder was dissolved. Then, 30 g of citric acid (J. T. Baker) was mixed with 80 ml of water and stirred until the citric acid powder was dissolved. The two solutions containing lithium hydroxide or citric acid respectively were mixed and stirred. 100 g of silica (Alderich 262951) was added and stirred for 1 hr.

Heat treatment: The above aqueous mixture was heated under nitrogen at 1100° C. for 3 hrs.

### Example 4

Preparation of aqueous mixture: 1 g of sodium hydroxide (Alfa Aesar) was mixed with 20 ml of water and stirred until the sodium hydroxide powder was dissolved. Then, 10 g of citric acid (J. T. Baker) was mixed with 80 ml of water and stirred until the citric acid powder was dissolved. The two solutions containing sodium hydroxide or citric acid respectively were mixed and stirred. 100 g of silica (Alderich 262951) was added and stirred for 1 hr.

Heat treatment: The above aqueous mixture was heated under nitrogen at 1100° C. for 3 hrs.

### Example 5

Preparation of aqueous mixture: 0.8 g of potassium hydroxide (Aldrich) was mixed with 20 ml of water and stirred until the potassium hydroxide powder was dissolved. Then, 10 g of citric acid (J. T. Baker) was mixed with 80 ml of water and stirred until the citric acid powder was dissolved. The two solutions containing potassium hydroxide or citric acid respectively were mixed and stirred. 100 g of silica (Alderich 262951) was added and stirred for 1 hr.

Heat treatment: The above aqueous mixture was heated under nitrogen at 1000° C. for 4 hrs.

### Example 6

Preparation of aqueous mixture: 0.12 g of magnesium hydroxide (Alfa Aesar) was mixed with 20 ml of water and stirred until the magnesium hydroxide powder was dissolved. Then, 10 g of citric acid (J. T. Baker) was mixed with 80 ml of water and stirred until the citric acid powder was dissolved. The two solutions containing magnesium hydroxide or citric acid respectively were mixed and stirred. 100 g of silica (Alderich 262951) was added and stirred for 1 hr.

Heat treatment: The above aqueous mixture was heated under nitrogen at 1000° C. for 4 hrs.

### Example 7

Preparation of aqueous mixture: 0.1 g of magnesium hydroxide (Alfa Aesar) was mixed with 20 ml of water and stirred until the magnesium hydroxide powder was dissolved. Then, 10 g of tartaric acid (J. T. Baker) was mixed with 80 ml of water and stirred until the tartaric acid powder was dissolved. The two solutions containing magnesium hydroxide or tartaric acid respectively were mixed and stirred. 100 g of silica (Alderich 262951) was added and stirred for 1 hr.

Heat treatment: The above aqueous mixture was heated under nitrogen at 900° C. for 5 hrs.

### Example 8

Preparation of aqueous mixture: 1 g of sodium hydroxide (Alfa Aesar) was mixed with 20 ml of water and stirred until the sodium hydroxide powder was dissolved. 15 g of poly-acrylic acid (Aldrich) was mixed with 80 ml of water and stirred until the polyacrylic acid powder was dissolved. The two solutions containing magnesium hydroxide or polyacrylic acid respectively were mixed and stirred. 100 g of silica (Alderich 262951) was added and stirred for 1 hr.

Heat treatment: The above aqueous mixture was heated under nitrogen at 900° C. for 5 hrs.

### Comparative Example 1

Preparation of aqueous mixture: 1 g of lithium hydroxide (Aldrich) was mixed with 20 ml of water and stirred until the lithium hydroxide powder was dissolved, and 100 g of silica (Alderich 262951) was added and stirred for 1 hr.

Heat treatment: The above aqueous mixture was heated under nitrogen at 1100° C. for 3 hrs.

### Comparative Example 2

Preparation of aqueous mixture: 10 g of citric acid (J. T. Baker) was mixed with 80 ml of water and stirred until the citric acid powder was dissolved, and 100 g of silica (Alderich 262951) was added and stirred for 1 hr.

Heat treatment: The above aqueous mixture was heated under nitrogen at 1100° C. for 3 hrs.

### Comparative Example 3

Preparation of aqueous mixture: 1 g of lithium hydroxide (Aldrich) was mixed with 20 ml of water and stirred until the lithium hydroxide powder was dissolved. Then, 1 g of citric acid (IT. Baker) was mixed with 80 ml of water and stirred until the citric acid powder was dissolved. The two solutions containing lithium hydroxide or citric acid respectively were mixed and stirred. 100 g of silica (Alderich 262951) was added and stirred for 1 hr.

Heat treatment: The above aqueous mixture was heated under nitrogen at 1200° C. for 3 hrs.

### Comparative Example 4

Preparation of aqueous mixture: 1 g of lithium hydroxide (Aldrich) was mixed with 20 ml of water and stirred until the lithium hydroxide powder was dissolved. Then, 40 g of citric acid (J. T. Baker) was mixed with 80 ml of water and stirred until the citric acid powder was dissolved. The two solutions containing lithium hydroxide or citric acid respectively were mixed and stirred. 100 g of silica (Alderich 262951) was added and stirred for 1 hr.

Heat treatment: The above aqueous mixture was heated under nitrogen at 1200° C. for 3 hrs.

### Comparative Example 5

Preparation of solid phase mixture: 1 g of lithium carbonate (Alfa Aesar), 10 g of citric acid and 100 g of silica (Alderich 262951) were mixed in a planetary mixer to obtain a uniform precursor powder.

Heat treatment: The precursor powder was heated under nitrogen at 1200° C. for 3 hrs.

### Comparative Example 6

Preparation of solid phase mixture: 1 g of lithium hydroxide (Alfa Aesar), 20 g of citric acid and 100 g of silica (Alderich 262951) were mixed in a high-speed pulverizer to obtain a uniform precursor powder.

Heat treatment: The precursor powder was heated under nitrogen at 1200° C. for 3 hrs.

### Comparative Example 7

Preparation of aqueous mixture: 05 g of lithium hydroxide (Aldrich) was mixed with 20 ml of water and stirred until the lithium hydroxide powder was dissolved. 15 g of xylitol (Sweet Town Enterprise Corp.) was mixed with 80 ml of water and stirred until the xylitol powder was dissolved. The two solutions containing lithium hydroxide or xylitol respectively were mixed and stirred. 100 g of silica (Alderich 262951) was added and stirred for 1 hr.

Heat treatment: The above aqueous mixture was heated under nitrogen at 1100° C. for 3 hrs.

### Comparative Example 8

Preparation of aqueous mixture: 0.8 g of lithium hydroxide (Aldrich) was mixed with 20 ml of water and stirred until the lithium hydroxide powder was dissolved. 25 g of sucrose (Aldrich) was mixed with 80 ml of water and stirred until the sucrose powder was dissolved. The two solutions containing lithium hydroxide or sucrose respectively were mixed and stirred. 100 g of silica (Alderich 262951) was added and stirred for 1 hr.

Heat treatment: The above aqueous mixture was heated under nitrogen at 1100° C. for 3 hrs.

The amounts of relevant ingredients are recorded in Table 1.

### Preparation of Negative Electrode and Lithium Ion Battery

Preparation of Slurry of Negative Electrode Materials

SBR: styrene-butadiene rubber, TRD104N provided by JSR.

CMC: carboxymethyl-cellulose, BVH8 provided by Ashland.

The silicon-based materials prepared in Comparative Examples 1 to 8 and Examples 1 to 8 were individually mixed with other components in an aqueous solution in the following proportions to prepare a slurry of negative electrode materials: 80 wt % silicon-based material, 4 wt % SBR, 6 wt % CMC, and 10 wt % conductive carbon black (Super P provided by Taiwan Maxwave CO., LTD).

Preparation of Electrode Sheet

The above-prepared slurry of negative electrode materials was coated by blade coating on a copper foil (10 μm copper foil for batteries provided by Changchun Group) [coating weight: 5-7 mg/cm²]. The obtained copper foil was dried at 100° C. for 5 min cold pressed, cut into a round shape with a cutter 12 mm in diameter, and heated in a vacuum oven at 100° C. for 6 hrs to obtain a negative electrode sheet.

Preparation of Button Cell

The electrolyte solution used contains 2% ethylene carbonate (EC)/diethyl carbonate (DEC)-vinylene carbonate (VC), 8% fluoroethylene carbonate (FEC) and lithium hexafluorophosphate (Formosa: LE). The separator is a polypropylene film with a thickness of about 20 μm.

The negative electrode sheet and other components were assembled by a conventional method into a standard button cell (CR2032) in an inert environment. The performance of the cell was tested. The following components were assembled in sequence: a bottom cover, a lithium metal sheet (as the cathode), the separator, the negative electrode sheet, a metal gasket, a spring sheet and a top cover.

The assembled cell was allowed to stand for about 2-3 hrs, to let the electrolyte solution fully permeate into the electrode to improve the conductivity. The open circuit voltage of the resulting cell was about 2.5-3 V.

### Test Methods

Test of Cell Performance

Battery performance was measured by a charge and discharge machine (model: LBT21084) from Arbin Instruments.

Pre-Process:

Charge: The cell was charged at a constant current of 0.1C for 10 hrs at a constant-current stage, and then charged at a constant voltage of 0.01 V for 1 hr at a constant-voltage stage (that is, the cell was charged to 0.01 V at a constant current (CC), and then charged to one percent of the originally set current at a constant voltage (CV).

Discharge: The battery was discharged at a current of 0.1C for 10 hrs.

Three rounds (3 cycles) of charge and discharge were repeated under the above conditions. The 3 cycles were used to form a solid electrolyte interface (SEI).

1^{st} coulombic efficiency: (discharge capacity of 1^{st} cycle of pre-process/charge capacity of 1^{st} cycle of pre-process)×100%.

After the pre-process was completed, cell performance was tested.

Test of Capacity Retention at High C Rate:

Charge: The cell was charged at a constant current of 1C for 1 hr at a constant-current stage, and then charged at a constant voltage of 0.01 V for 1 hr at a constant-voltage stage.

Discharge: The battery was discharged at a current of 1C for 1 hr.

50 rounds (50 cycles at high C rate) of charge and discharge were repeated under the above conditions, to test the capacity retention at high C rate.

Capacity retention at high C rate: discharge capacity of the 50th cycle at high C rate/discharge capacity of the first cycle at high C rate)×100%.

Rate Capability Test:

Charge: The cell was charged at a constant current of 0.1C for 10 hrs at a constant-current stage, and then charged at a constant voltage of 0.01 V for 1 hr at a constant-voltage stage.

Discharge: The battery was discharged at a current of 1C for 1 hr.

Rate capability: (discharge capacity at 1C/charge capacity at 0.1C)×100%.

### Test Results

No carbon source compound was used in Comparative Example 1; no metal source compound was used in Comparative Example 2; not enough carbon source compound was used in Comparative Example 3; too much carbon source compound was used in Comparative Example 4; and a solid-phase mixture was used to prepare the silicon-based materials in Comparative Examples 5 and 6. In contrast, an aqueous mixture of a silicon oxide raw material, a metal source compound and a carbon source compound was used to prepare the silicon-based materials in Examples 1 to 8.

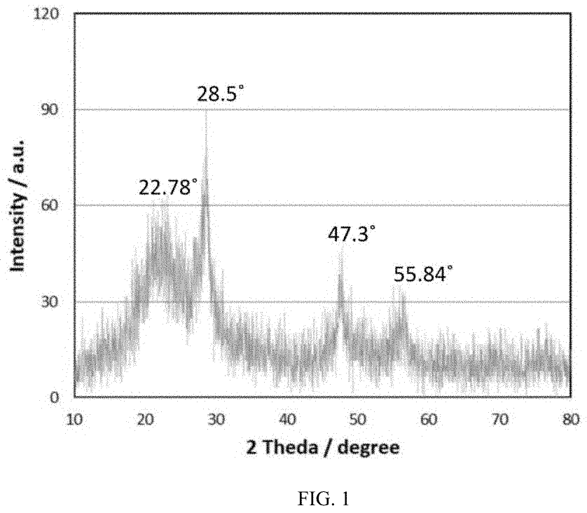

FIG. 1 shows an X-ray diffraction pattern (Cu Kα rays) of the silicon-based material prepared in Example 1. The silicon-based material has the following characteristic peaks: (A) a characteristic peak at 2θ=23°±1° (with an intensity I_{A}); (B) a characteristic peak at 2θ=28°±0.5° (with an intensity I_{B}); (C) a characteristic peak at 2θ=48°±1° (with an intensity I_{C}); and (D) a characteristic peak at 2θ=56°±1° (with an intensity I_{D}), where I_{B}/I_{A}=1.23; I_{B}/I_{C}=1.96; and I_{B}/I_{D}=2.14, which meet the relative intensity requirements for the characteristic peaks in the X-ray diffraction pattern of the silicon-based material of the present invention: 1.2≤I_{B}/I_{A}≤1.7; 1.8≤I_{B}/I_{C}≤2.3; and 1.6≤I_{B}/I_{D}≤3.0.

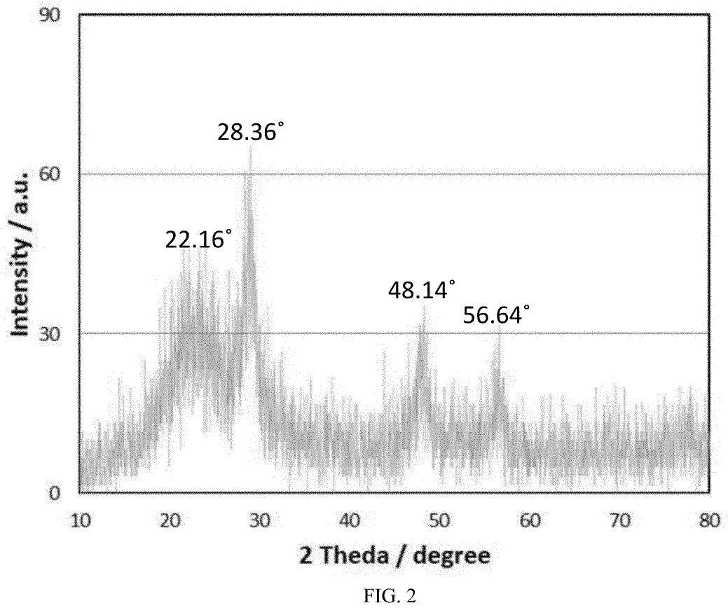

FIG. 2 shows an X-ray diffraction pattern (Cu Kα rays) of the silicon-based material prepared in Example 2. The silicon-based material has the following characteristic peaks: (A) a characteristic peak at 2θ=23°±1° (with an intensity I_{A}); (B) a characteristic peak at 2θ=28°±0.5° (with an intensity I_{B}); (C) a characteristic peak at 2θ=48°±1° (with an intensity I_{C}); and (D) a characteristic peak at 2θ=56°±1^{st} (with an intensity I_{D}), where I_{B}/I_{A}=1.44; I_{B}/I_{C}=1.80; and I_{B}/I_{D}=1.89, which meet the relative intensity requirements for the characteristic peaks in the X-ray diffraction pattern of the silicon-based material of the present invention: 1.2≤I_{B}/I_{A}≤1.7; 1.8≤I_{B}/I_{C}≤2.3; and 1.6≤I_{B}/I_{D}≤3.0.

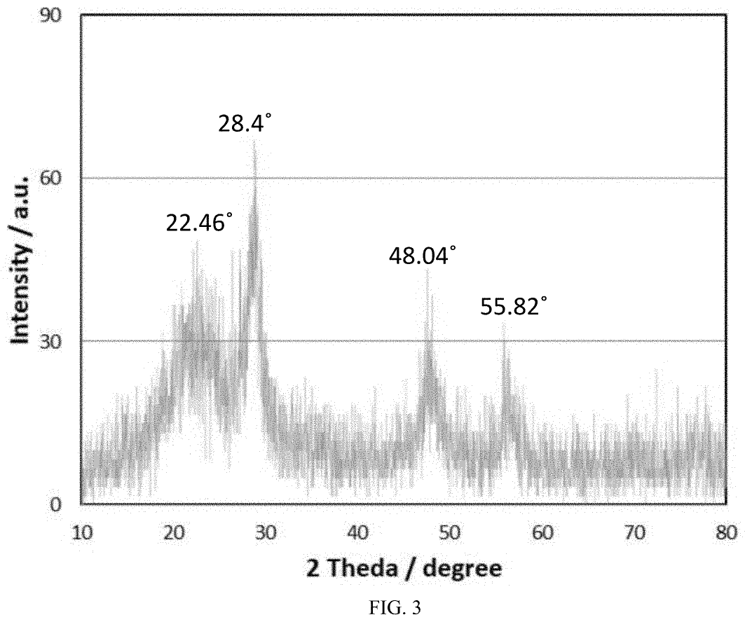

FIG. 3 shows an X-ray diffraction pattern (Cu Kα rays) of the silicon-based material prepared in Example 3. The silicon-based material has the following characteristic peaks: (A) a characteristic peak at 2θ=23°±1°(with an intensity I_{A}); (B) a characteristic peak at 2θ=28°±0.5° (with an intensity I_{B}); (C) a characteristic peak at 2θ=48°±1° (with an intensity I_{C}); and (D) a characteristic peak at 2θ=56°±1° (with an intensity I_{D}), where I_{B}/I_{A}=1.32; I_{B}/I_{C}=1.83; and I_{B}/I_{D}=1.65, which meet the relative intensity requirements for the characteristic peaks in the X-ray diffraction pattern of the silicon-based material of the present invention: 1.2≤I_{B}/I_{A}≤1.7; 1.8≤I_{B}/I_{C}≤2.3; and 1.6≤I_{B}/I_{D}≤3.0.

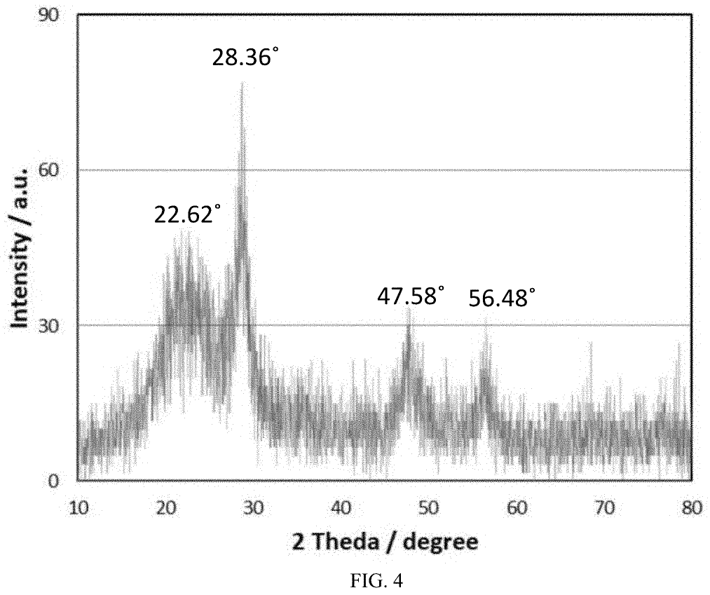

FIG. 4 shows an X-ray diffraction pattern (Cu Kα rays) of the silicon-based material prepared in Example 4. The silicon-based material has the following characteristic peaks: (A) a characteristic peak at 2θ=23°±1° (with an intensity I_{A}); (B) a characteristic peak at 2θ=28°±0.5° (with an intensity I_{B}); (C) a characteristic peak at 2θ=48°±1° (with an intensity I_{C}); and (D) a characteristic peak at 2θ=56°±1° (with an intensity I_{D}), where I_{B}/I_{A}=1.31; I_{B}/I_{C}=1.90; and I_{B}/I_{D}=2.00, which meet the relative intensity requirements for the characteristic peaks in the X-ray diffraction pattern of the silicon-based material of the present invention: 1.2≤I_{B}/I_{A}≤1.7; 1.8≤I_{B}/I_{C}2.3; and 1.6≤I_{B}/I_{D}≤3.0.

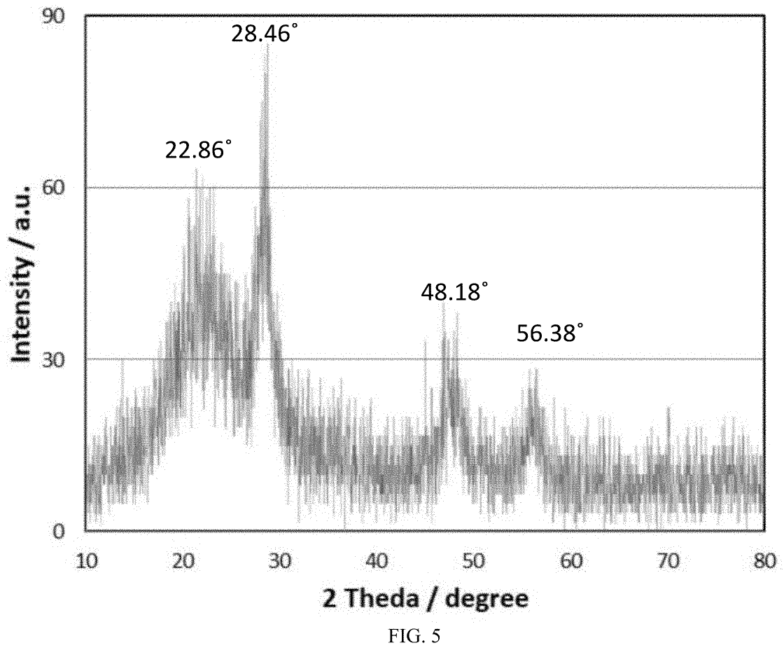

FIG. 5 shows an X-ray diffraction pattern (Cu Kα rays) of the silicon-based material prepared in Example 5. The silicon-based material has the following characteristic peaks: (A) a characteristic peak at 2θ=23°±1° (with an intensity I_{A}); (B) a characteristic peak at 2θ=28°±0.5° (with an intensity I_{B}); (C) a characteristic peak at 2θ=48°±1° (with an intensity I_{C}); and (D) a characteristic peak at 2θ=56°±1° (with an intensity I_{D}), where I_{B}/I_{A}=1.54; I_{B}/I_{C}=2.00; and I_{B}/I_{D}=2.35, which meet the relative intensity requirements for the characteristic peaks in the X-ray diffraction pattern of the silicon-based material of the present invention: 1.2≤I_{B}/I_{A}≤1.7; 1.8≤I_{B}/I_{C}≤2.3; and 1.6≤I_{B}/I_{D}≤3.0.

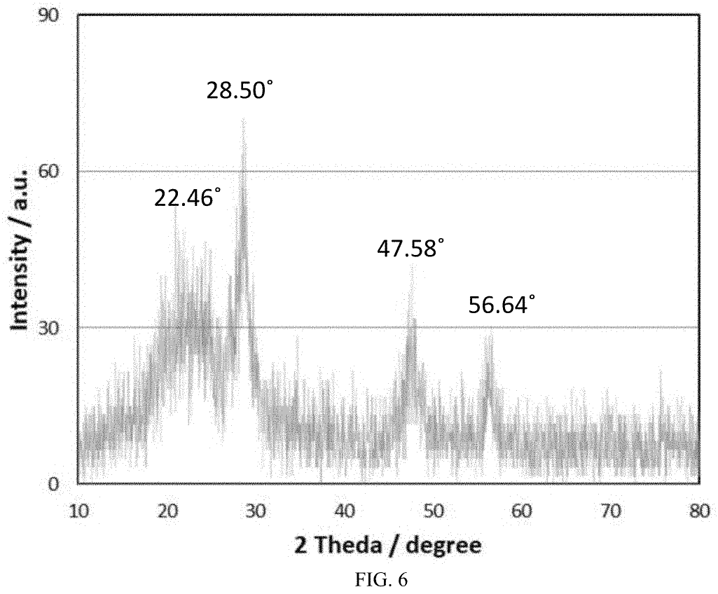

FIG. 6 shows an X-ray diffraction pattern (Cu Kα rays) of the silicon-based material prepared in Example 6. The silicon-based material has the following characteristic peaks: (A) a characteristic peak at 2θ=23°±1° (with an intensity I_{A}); (B) a characteristic peak at 2θ=28°±0.5° (with an intensity I_{B}); (C) a characteristic peak at 2θ=48°±1° (with an intensity I_{C}); and (D) a characteristic peak at 2θ=56°±1° (with an intensity I_{D}), where I_{B}/I_{A}=1.65; I_{B}/I_{C}=1.90; and I_{B}/I_{D}=2.24, which meet the relative intensity requirements for characteristic peaks in the X-ray diffraction pattern of the silicon-based material of the present invention: 1.2≤I_{B}/I_{A}≤1.7; 1.8≤I_{B}/I_{C}≤2.3; and 1.6≤I_{B}/I_{D}≤3.0.

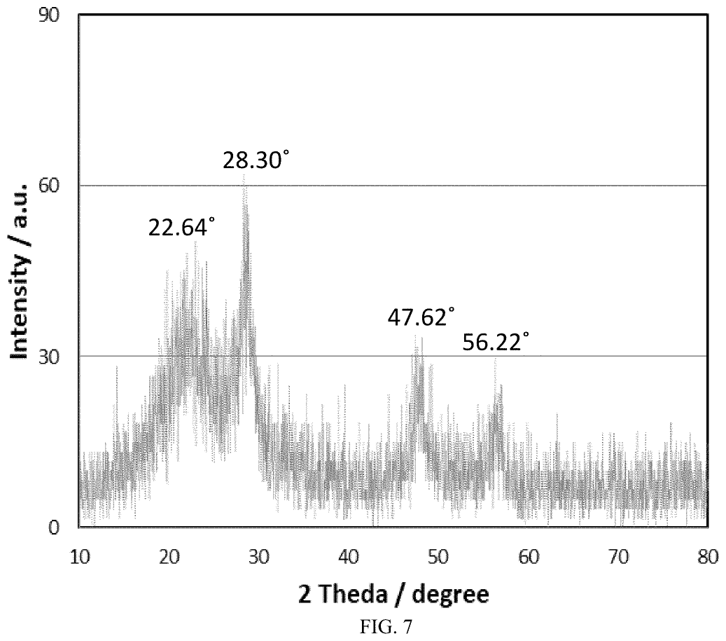

FIG. 7 shows all X-ray diffraction pattern (Cu Kα rays) of the silicon-based material prepared in Example 7. The silicon-based material has the following characteristic peaks: (A) a characteristic peak at 2θ=23°±1° (with an intensity I_{A}); (B) a characteristic peak at 2θ=28°±0.5° (with an intensity I_{B}); (C) a characteristic peak at 2θ=48°±1° (with an intensity I_{C}); and (D) a characteristic peak at 2θ=56°±1° (with an intensity I_{D}), where I_{B}/I_{A}=1.42; I_{B}/I_{C}=1.95; and I_{B}/I_{D}=2.08, which meet the relative intensity requirements for the characteristic peaks in the X-ray diffraction pattern of the silicon-based material of the present invention: 1.2≤I_{B}/I_{A}≤1.7; 1.8≤I_{B}/I_{C}≤2.3; and 1.6≤I_{B}/I_{D}≤3.0.

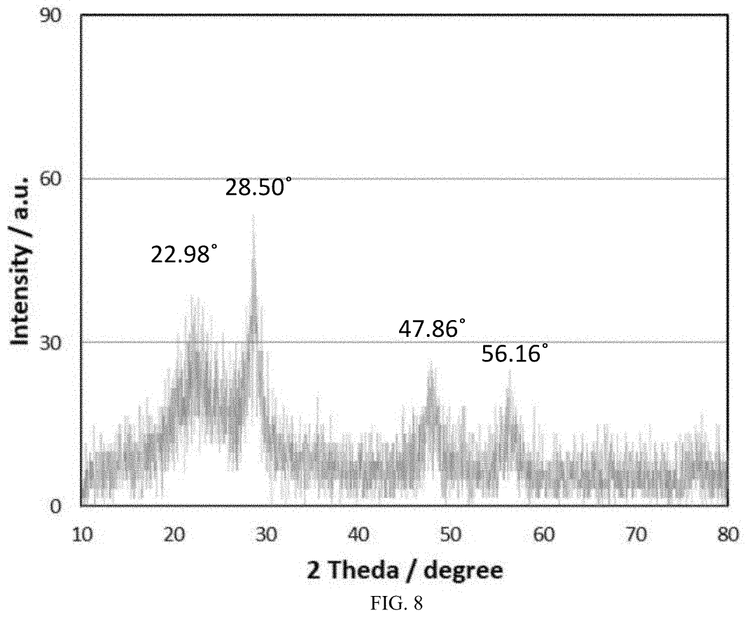

FIG. 8 shows an X-ray diffraction pattern (Cu Kα rays) of the silicon-based material prepared in Example 8. The silicon-based material has the following characteristic peaks: (A) a characteristic peak at 2θ=23°±1° (with an intensity I_{A}); (B) a characteristic peak at 2θ=28°±0.5° (with an intensity I_{B}); (C) a characteristic peak at 2θ=48°±1° (with an intensity I_{C}); and (D) a characteristic peak at 2θ=56°±1° (with an intensity I_{D}), where I_{B}/I_{A}=1.35; I_{B}/I_{C}=1.89; and I_{B}/I_{D}=2.08, which meet the relative intensity requirements for the characteristic peaks in the X-ray diffraction pattern of the silicon-based material of the present invention: 1.2≤I_{B}/I_{A}≤1.7; 1.8≤I_{B}/I_{C}≤2.3; and 1.65≤I_{B}/I_{D}≤3.0.

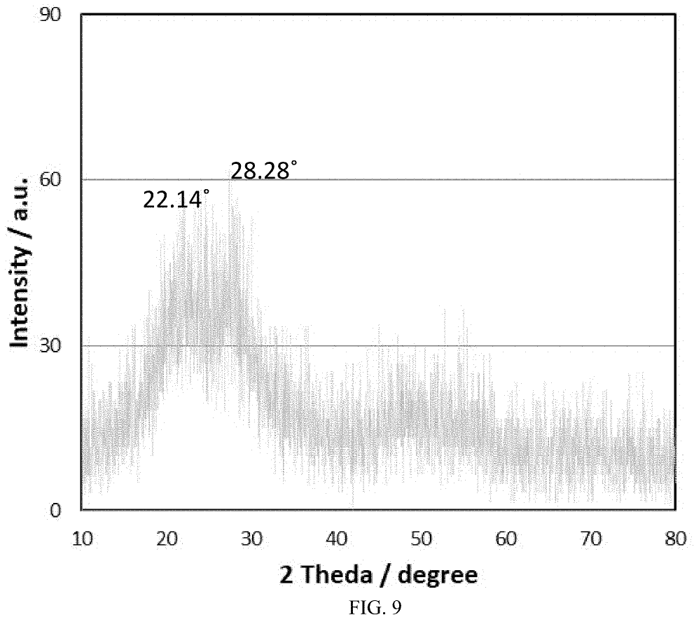

FIG. 9 shows an X-ray diffraction pattern (Cu Kα rays) of the silicon-based material prepared in Comparative Example 1. The silicon-based material does not have the following characteristic peaks: (C) a characteristic peak at 2θ=48°±1 and (D) a characteristic peak at 2θ=56°±1°.

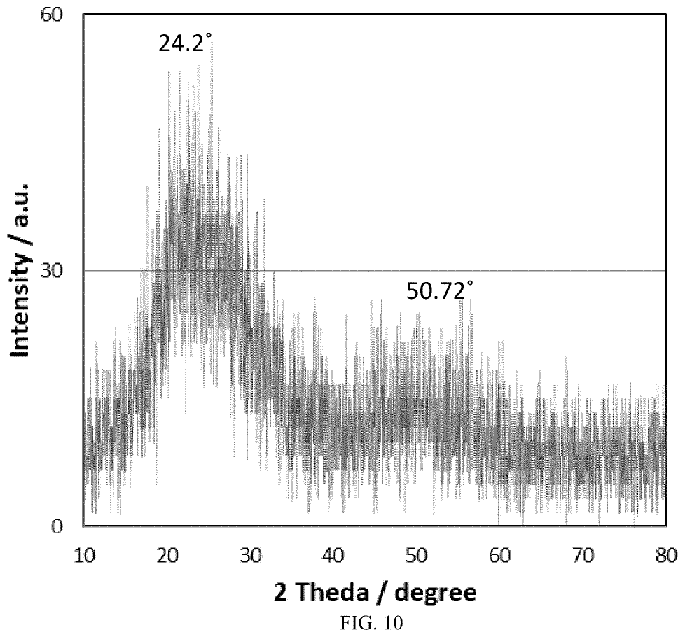

FIG. 10 shows an X-ray diffraction pattern (Cu Kα rays) of the silicon-based material prepared in Comparative Example 2. The silicon-based material does not have the following characteristic peaks: (A) a characteristic peak at 2θ=23°±1°; (B) a characteristic peak at 2θ=28°±0.5°; (C) a characteristic peak at 2θ=48°±1°; and (D) a characteristic peak at 2θ=56°±1°.

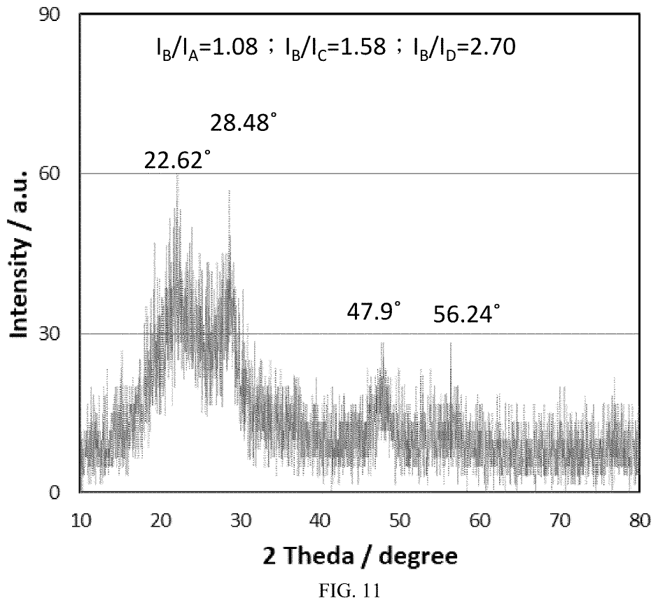

FIG. 11 shows an X-ray diffraction pattern (Cu Kα rays) of the silicon-based material prepared in Comparative Example 3. The silicon-based material has the following characteristic peaks: (A) a characteristic peak at 2θ=23°±1° (with an intensity I_{A}); (B) a characteristic peak at 2θ=28°±0.5° (with an intensity I_{A}); (C) a characteristic peak at 2θ=48°±1° (with an intensity I_{C}); and (D) a characteristic peak at 2θ=56°±1° (with an intensity I_{D}). However, the relative intensities of these characteristic peaks are I_{B}/I_{A}=1.08; I_{B}/I_{C}=1.58; and I_{B}/I_{D}=2.70, which do not meet the relative intensity requirements for the characteristic peaks in the X-ray diffraction pattern of the silicon-based material of the present invention: 1.2≤I_{B}/I_{A}≤1.7; 1.8≤I_{B}/I_{C}≤2.3; and 1.6≤I_{B}/I_{D}≤3.0.

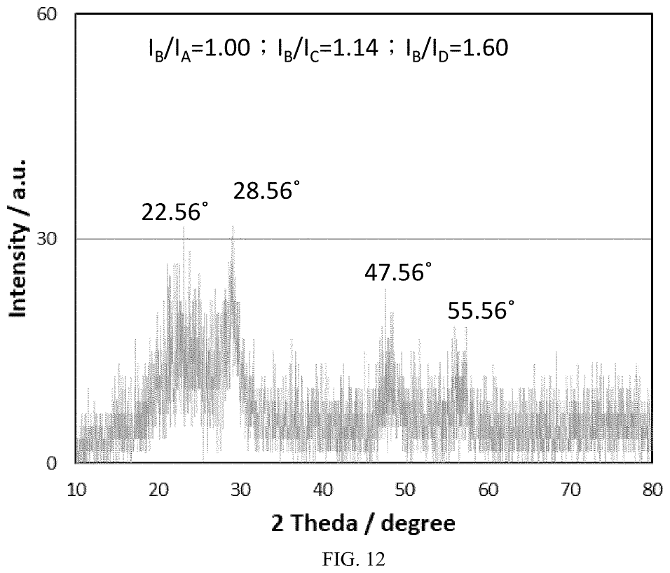

FIG. 12 shows an X-ray diffraction pattern (Cu Kα rays) of the silicon-based material prepared in Comparative Example 4. The silicon-based material has the following characteristic peaks: (A) a characteristic peak at 2θ=23°±1° (with an intensity I_{A}); (B) a characteristic peak at 2θ=28°±0.5° (with an intensity I_{B}); (C) a characteristic peak at 2θ=48°±1°(with an intensity I_{C}); and (D) a characteristic peak at 2θ=56°±1° (with an intensity I_{D}). However, the relative intensities of these characteristic peaks are I_{B}/I_{A}=1.00; I_{B}/I_{C}=1.14; and I_{B}/I_{D}=1.60, which do not meet the relative intensity requirements for the characteristic peaks in the X-ray diffraction pattern of the silicon-based material of the present invention: 1.2≤I_{B}/I_{A}≤1.7; 1.8≤I_{B}/I_{C}≤2.3: and 1.6≤I_{B}/I_{D}≤3.0.

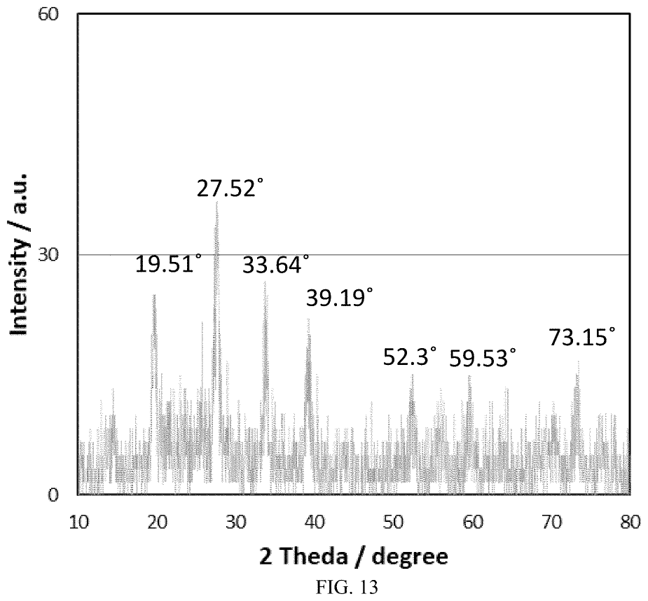

FIG. 13 shows an X-ray diffraction pattern (Cu Kα rays) of the silicon-based material prepared in Comparative Example 5. The silicon-based material does not have the following characteristic peaks: (A) a characteristic peak at 2θ=23°±1°: (B) a characteristic peak at 2θ=28°±0.5°; (C) a characteristic peak at 2θ=48°±1°; and (D) a characteristic peak at 2θ=56°±1°. Moreover, the X-ray diffraction pattern in FIG. 13 has characteristic peaks at 2θ=19.51°, 33.64°, and 39.19°.

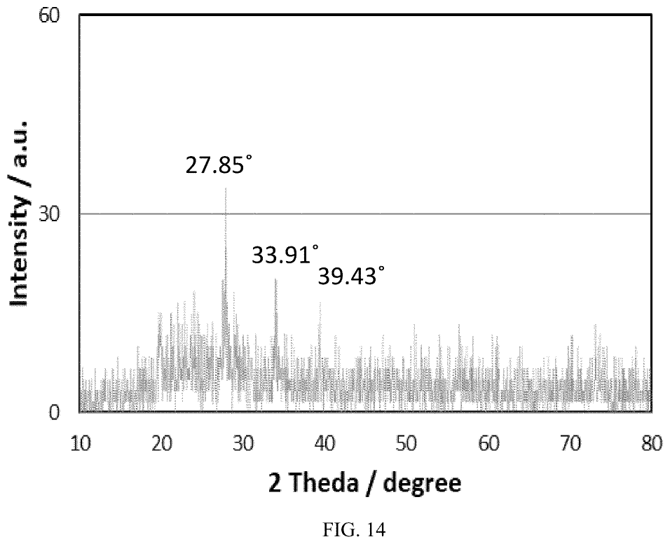

FIG. 14 shows an X-ray diffraction pattern (Cu Kα rays) of the silicon-based material prepared in Comparative Example 6. The silicon-based material does not have the following characteristic peaks: (A) a characteristic peak at 2θ=23°±1°; (C) a characteristic peak at 2θ=48°±1°; and (D) a characteristic peak at 2θ=56°±1°. Moreover, the X-ray diffraction pattern of Comparative Example 6 has characteristic peaks at 2θ=33.91° and 39.43°.

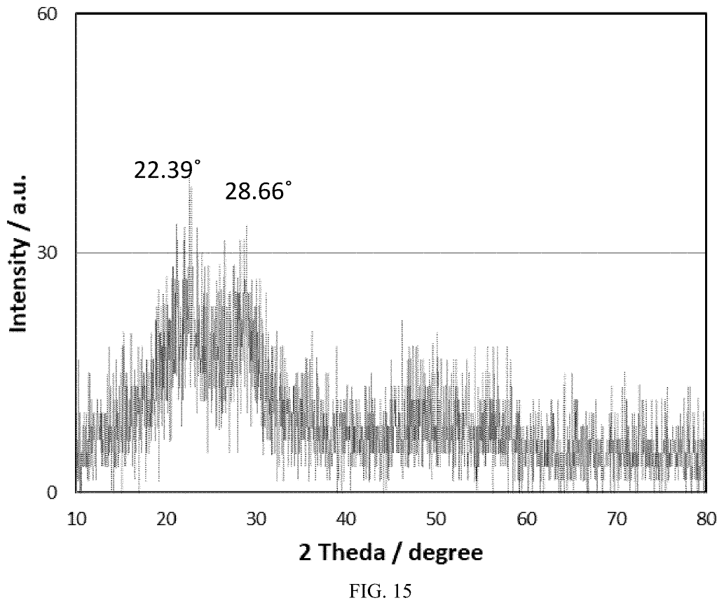

FIG. 15 shows an X-ray diffraction pattern (Cu Kα rays) of the silicon-based material prepared in Comparative Example 7. The silicon-based material does not have the following characteristic peaks: (C) a characteristic peak at 2θ=48°±1°; and (D) a characteristic peak at 2θ=56°±1°.

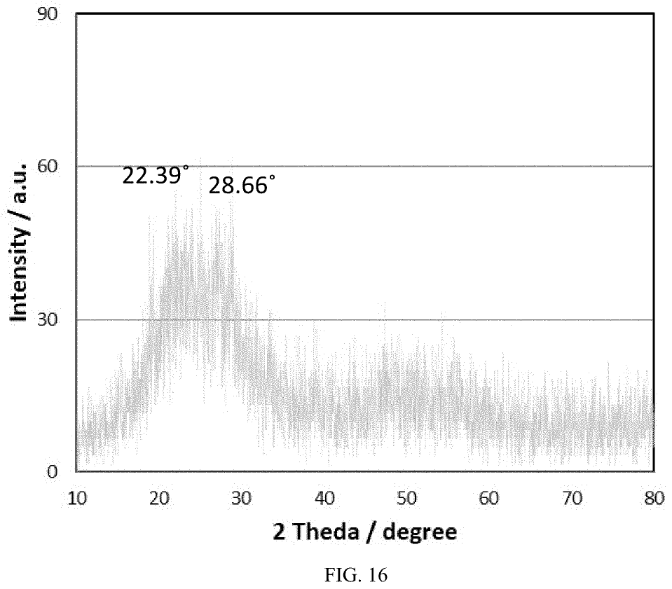

FIG. 16 shows an X-ray diffraction pattern (Cu Ku rays) of the silicon-based material prepared in Comparative Example 8. The silicon-based material does not have the following characteristic peaks: (C) a characteristic peak at 2θ=48°±1°; and (D) a characteristic peak at 2θ=56°±1°.

It can be seen from Table 1 that the silicon-based materials papered by the method of the present invention in Examples 1 to 8 have specific crystallinity. The prepared negative electrode of the lithium-ion battery has good 1^{st} coulombic efficiency (for example, 78% or higher), rate capability (for example, 70% or higher) and capacity retention at high C rate (for example, 40% or higher) and other favorable performance attributes. In contrast, at least one of the 1^{st} coulombic efficiency, rate capability and capacity retention at high C rate of the negative electrodes prepared in Comparative Examples 1 to 8 is not as good as the performance of Examples 1 to 8.

Those skilled in the art will understand that various modifications and changes can be made to the present invention without departing from the scope or spirit of the present invention. In view of the foregoing, the present invention is intended to cover modifications and changes of the present invention, as long as these modifications and changes fall within the scope of the claims of the present application and their equivalents.

TABLE 1

| | Comparative Examples | | | | | | | | Examples |
|---|---|---|---|---|---|---|---|---|---|
| | 1 | 2 | 3 | 4 | 5 | 6 | 7 | 8 | 1 |
| Silica (g) | 100 | 100 | 100 | 100 | 100 | 100 | 100 | 100 | 100 |
| Lithium hydroxide (g) | 1 | 0 | 1 | 1 | 0 | 1 | 0.5 | 0.8 | 1 |
| Sodium hydroxide (g) | 0 | 0 | 0 | 0 | 0 | 0 | 0 | 0 | 0 |
| Potassium hydroxide (g) | 0 | 0 | 0 | 0 | 0 | 0 | 0 | 0 | 0 |
| Magnesium hydroxide (g) | 0 | 0 | 0 | 0 | 0 | 0 | 0 | 0 | 0 |
| Lithium carbonate (g) | 0 | 0 | 0 | 0 | 1 | 0 | 0 | 0 | 0 |
| Critic acid (g) | 0 | 10 | 1 | 40 | 10 | 20 | 0 | 0 | 10 |
| Xylitol (g) | 0 | 0 | 0 | 0 | 0 | 0 | 15 | 0 | 0 |
| Sucrose (g) | 0 | 0 | 0 | 0 | 0 | 0 | 0 | 25 | 0 |
| Tartaric acid (g) | 0 | 0 | 0 | 0 | 0 | 0 | 0 | 0 | 0 |
| Polyacrylic acid (g) | 0 | 0 | 0 | 0 | 0 | 0 | 0 | 0 | 0 |
| Mixture: Aqueous | Aqueous | Aqueous | Aqueous | Aqueous | Solid | Solid | Aqueous | Aqueous | Aqueous |
| phase/solid phase | phase | phase | phase | phase | phase | phase | phase | phase | phase |
| 1^{st} coulombic | 64 | 68 | 58 | 80 | 75 | 62 | 60 | 65 | 82 |
| efficiency (%) | | | | | | | | | |
| Rate capability (%) | 43 | 28 | 31 | 69 | 47 | 55 | 40 | 38 | 82 |
| Capacity retention | 17 | 23 | 11 | 31 | 23 | 27 | 19 | 20 | 69 |
| at high C rate (%) | | | | | | | | | |

| | Examples | | | | | | |
|---|---|---|---|---|---|---|---|
| | 2 | 3 | 4 | 5 | 6 | 7 | 8 |
| Silica (g) | 100 | 100 | 100 | 100 | 100 | 100 | 100 |
| Lithium hydroxide (g) | 0.2 | 0.1 | 0 | 0 | 0 | 0 | 0 |
| Sodium hydroxide (g) | 0 | 0 | 1 | 0 | 0 | 0 | 1 |
| Potassium hydroxide (g) | 0 | 0 | 0 | 0.8 | 0 | 0 | 0 |
| Magnesium hydroxide (g) | 0 | 0 | 0 | 0 | 0.12 | 0.1 | 0 |
| Lithium carbonate (g) | 0 | 0 | 0 | 0 | 0 | 0 | 0 |
| Critic acid (g) | 20 | 30 | 10 | 10 | 10 | 0 | 0 |
| Xylitol (g) | 0 | 0 | 0 | 0 | 0 | 0 | 0 |
| Sucrose (g) | 0 | 0 | 0 | 0 | 0 | 0 | 0 |
| Tartaric acid (g) | 0 | 0 | 0 | 0 | 0 | 10 | 0 |
| Polyacrylic acid (g) | 0 | 0 | 0 | 0 | 0 | 0 | 15 |
| Mixture: Aqueous | Aqueous | Aqueous | Aqueous | Aqueous | Aqueous | Aqueous | Aqueous |
| phase/solid phase | phase | phase | phase | phase | phase | phase | phase |
| 1^{st} coulombic | 80 | 79 | 78 | 82 | 80 | 83 | 81 |
| efficiency (%) | | | | | | | |
| Rate capability (%) | 79 | 87 | 72 | 77 | 75 | 74 | 80 |
| Capacity retention | 44 | 71 | 44 | 53 | 65 | 48 | 60 |
| at high C rate (%) | | | | | | | |

What is claimed is:

1. A silicon-based material, wherein in an X-ray diffraction pattern obtained by using Cu Kα rays, the silicon-based material comprises the following characteristic peaks:
(A) a characteristic peak at 2θ=23°±1° with an intensity I_{A};
(B) a characteristic peak at 2θ=28°±0.5° with an intensity I_{B};
(C) a characteristic peak at 2θ=48°±1° with an intensity I_{C}; and
(D) a characteristic peak at 2θ=56°±1° with an intensity I_{D},
and wherein:
1.2≤I_{B}/I_{A}≤1.7;
1.8≤I_{B}/I_{C}≤2.3; and
1.6≤I_{B}/I_{D}≤3.0.

2. The silicon-based material of claim 1, wherein the silicon-based material is in powder form and has an average particle size (D₅₀) of 2 μm to 10 μm.

3. The silicon-based material of claim 1, wherein the silicon-based material comprises a silicon compound particle, a carbon material and a metal element.

4. The silicon-based material of claim 3, wherein based on the total weight of the silicon-based material taken as 100 wt %, a content of the silicon compound particle is 69 wt % to 98 wt %.

5. The silicon-based material of claim 3, wherein based on the total weight of the silicon-based material taken as 100 wt %, a content of the carbon material is 1 wt % to 30 wt %.

6. The silicon-based material of claim 3, wherein based on the total weight of the silicon-based material taken as 100 wt %, a content of the metal element is 0.1 wt % to 1 wt %.

7. The silicon-based material of claim 3, wherein the silicon compound particle comprises a silicon compound SiOₓ, wherein 0≤x≤2, and the metal element comprises an alkali metal or an alkaline earth metal.

8. A method for preparing a silicon-based material, comprising:
mixing a metal source compound, a carbon source compound and a silicon oxide raw material with water to obtain an aqueous mixture; and
subjecting the aqueous mixture to heat treatment.

9. The method of claim 8, wherein the metal source compound comprises lithium hydroxide, sodium hydroxide, potassium hydroxide, magnesium hydroxide, or any combination thereof.

10. The method of claim 8, wherein the carbon source compound comprises citric acid, malic acid, tartaric acid, polyacrylic acid, and maleic acid, or a combination thereof.

11. The method of claim 8, wherein based on 100 parts by weight of the silicon oxide raw material, an amount of the metal source compound is 0.1 part by weight to 1 part by weight.

12. The method of claim 8, wherein based on 100 parts by weight of the silicon oxide raw material, an amount of the carbon source compound is 10 parts by weight to 30 parts by weight.

13. A battery negative electrode, comprising the silicon-based material of claim 1.
